(19) United States
(12) Patent Application Publication
(10) Pub. No.: US 2023/0153681 A1
(43) Pub. Date: May 18, 2023

(54) MACHINE LEARNING TECHNIQUES FOR HYBRID TEMPORAL-UTILITY CLASSIFICATION DETERMINATIONS

(71) Applicant: UnitedHealth Group Incorporated, Minnetonka, MN (US)

(72) Inventors: Subhadradevi KYANAM, Plymouth, MN (US); Apoorva NIGAM, Lucknow (IN); Vaishnavi V. G, Delhi (IN); Raghvendra Kumar YADAV, Greater Noida (IN); Biswajit BHATTACHARJEE, Kolkata (IN); Anders WOLF, Woodbury, MN (US)

(21) Appl. No.: 17/528,001

(22) Filed: Nov. 16, 2021

(51) Int. Cl. G06N 20/00; G06K 9/62; G06N 5/00

(52) U.S. Cl. CPC G06N 20/00; G06K 9/6265; G06N 5/003

(57) ABSTRACT

Various embodiments of the present invention provide methods, apparatus, systems, computing devices, computing entities, and/or the like for performing predictive data analysis operations by dynamically determining a hybrid temporal-utility classification for a predictive entity. The hybrid temporal-utility classification for the predictive entity may be determined based at least in part on outputs from a temporal score generation machine learning model and a utility score generation machine learning model.

### BACKGROUND

Various embodiments of the present invention address technical challenges related to improving efficiency, reliability, and operational throughput of user engagement systems.

### BRIEF SUMMARY

In general, embodiments of the present invention provide methods, apparatuses, systems, computing devices, computing entities, and/or the like for performing predictive data analysis operations for a predictive entity based at least in part on a determined hybrid classification for the predictive entity. For example, certain embodiments of the present invention utilize systems, methods, and computer program products that dynamically determine a hybrid temporal-utility classification for a predictive entity.

In accordance with one aspect, a method includes: determining, using one or more processors and a temporal classification score generation machine learning model, a temporal classification for the predictive entity, wherein: (i) the temporal classification score generation machine learning model is configured to determine a temporal classification score based at least in part on one or more temporal classification input features for the predictive entity, (ii) the temporal classification score describes a non-extremal periodicity likelihood measure for the predictive entity, (iii) the non-extremal periodicity likelihood measure is defined based at least in part on a non-extremal prospective period, (iv) the non-extremal prospective period is defined based at least in part on at least one of a lower extremal prospective period and an upper extremal prospective period, (v) the temporal classification is determined based at least in part on the temporal classification score and a temporal classification policy, and (vi) the one or more temporal classification input features include an entity cost density feature for the predictive entity; determining, using the one or more processors and a utility classification score generation machine learning model, a utility classification for the predictive entity, wherein: the utility score generation machine learning model is configured to: (i) for each timeseries processing machine learning model of a plurality of timeseries processing machine learning models, determine an error measure with respect to a historical utility timeseries data object associated with the predictive entity, (ii) generate a forecasted utility classification timeseries data object for the predictive entity based at least in part on an output of processing the historical utility timeseries data object using an error-minimizing timeseries processing machine learning model, and (iii) generate a utility classification score for the predictive entity based at least in part on the forecasted utility classification timeseries data object, and the utility classification is determined based at least in part on the utility classification score and a utility classification policy; determining, using the one or more processors and based at least in part on the temporal classification and the utility classification, the hybrid temporal-utility classification; determining, using the one or more processors, one or more prediction-based actions based at least in part on the hybrid temporal-utility classification; and performing the one or more prediction-based actions.

In accordance with another aspect, an apparatus comprising at least one processor and at least one memory including program code, the at least one memory and the program code configured to, with the processor, cause the apparatus to at least: determine, using a temporal classification score generation machine learning model, a temporal classification for the predictive entity, wherein: (i) the temporal classification score generation machine learning model is configured to determine a temporal classification score based at least in part on one or more temporal classification input features for the predictive entity, (ii) the temporal classification score describes a non-extremal periodicity likelihood measure for the predictive entity, (iii) the non-extremal periodicity likelihood measure is defined based at least in part on a non-extremal prospective period, (iv) the non-extremal prospective period is defined based at least in part on at least one of a lower extremal prospective period and an upper extremal prospective period, (v) the temporal classification is determined based at least in part on the temporal classification score and a temporal classification policy, and (vi) the one or more temporal classification input features include an entity cost density feature for the predictive entity; determine, using a utility classification score generation machine learning model, a utility classification for the predictive entity, wherein: the utility score generation machine learning model is configured to: (i) for each timeseries processing machine learning model of a plurality of timeseries processing machine learning models, determine an error measure with respect to a historical utility timeseries data object associated with the predictive entity, (ii) generate a forecasted utility classification timeseries data object for the predictive entity based at least in part on an output of processing the historical utility timeseries data object using an error-minimizing timeseries processing machine learning model, and (iii) generate a utility classification score for the predictive entity based at least in part on the forecasted utility classification timeseries data object, and the utility classification is determined based at least in part on the utility classification score and a utility classification policy; determine, based at least in part on the temporal classification and the utility classification, the hybrid temporal-utility classification; determine one or more prediction-based actions based at least in part on the hybrid temporal-utility classification; and perform the one or more prediction-based actions.

In accordance with yet another aspect, a computer program product computer program comprising at least one non-transitory computer-readable storage medium having computer-readable program code portions stored therein, the computer-readable program code portions configured to: determine, using a temporal classification score generation machine learning model, a temporal classification for the predictive entity, wherein: (i) the temporal classification score generation machine learning model is configured to determine a temporal classification score based at least in part on one or more temporal classification input features for the predictive entity, (ii) the temporal classification score describes a non-extremal periodicity likelihood measure for the predictive entity, (iii) the non-extremal periodicity likelihood measure is defined based at least in part on a non-extremal prospective period, (iv) the non-extremal prospective period is defined based at least in part on at least one of a lower extremal prospective period and an upper extremal prospective period, (v) the temporal classification is determined based at least in part on the temporal classification score and a temporal classification policy, and (vi) the one or more temporal classification input features include an entity cost density feature for the predictive entity; determine, using a utility classification score generation machine learning model, a utility classification for the predictive entity, wherein: the utility score generation machine learning model is configured to: (i) for each timeseries processing machine learning model of a plurality of timeseries processing machine learning models, determine an error measure with respect to a historical utility timeseries data object associated with the predictive entity, (ii) generate a forecasted utility classification timeseries data object for the predictive entity based at least in part on an output of processing the historical utility timeseries data object using an error-minimizing timeseries processing machine learning model, and (iii) generate a utility classification score for the predictive entity based at least in part on the forecasted utility classification timeseries data object, and the utility classification is determined based at least in part on the utility classification score and a utility classification policy; determine, based at least in part on the temporal classification and the utility classification, the hybrid temporal-utility classification; determine one or more prediction-based actions based at least in part on the hybrid temporal-utility classification; and perform the one or more prediction-based actions.

### BRIEF DESCRIPTION OF THE DRAWINGS

Having thus described the invention in general terms, reference will now be made to the accompanying drawings, which are not necessarily drawn to scale, and wherein:

FIG. 1 provides an exemplary overview of a system that can be used to practice embodiments of the present invention;

FIG. 2 provides an example predictive data analysis computing entity in accordance with some embodiments discussed herein;

FIG. 3 provides an example external computing entity in accordance with some embodiments discussed herein;

FIG. 4 provides a flowchart diagram of an example process for determining a hybrid temporal-utility classification in accordance with some embodiments discussed herein;

FIG. 5 provides a flowchart diagram of an example process for determining a utility classification score in accordance with some embodiments discussed herein;

FIG. 6 provides an operational example of a temporal classification policy for determination of a temporal classification for a predictive entity in accordance with some embodiments discussed herein;

FIG. 7 provides an operational example of a utility classification policy for determination of a utility classification for a predictive entity in accordance with some embodiments discussed herein;

FIG. 8 provides an operational example of a hybrid temporal-utility classification determination for a predictive entity in accordance with some embodiments discussed herein;

FIG. 9 provides an operational example of a decision tree object for use with performing one or more prediction-based actions in accordance with some embodiments discussed herein; and

FIG. 10 provides an operational example of a prediction output user interface that is configured to describe a hybrid temporal-utility classification summary data object that is generated for a predictive entity in accordance with some embodiments discussed herein.

### DETAILED DESCRIPTION

Various embodiments of the present invention are described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “exemplary” are used to be examples with no indication of quality level. Like numbers refer to like elements throughout. Moreover, while certain embodiments of the present invention are described with reference to predictive data analysis, one of ordinary skill in the art will recognize that the disclosed concepts can be used to perform other types of data analysis.

### I. Overview and Technical Advantages

Various embodiments of the present invention introduce techniques for targeting engagement actions based at least in part on reliable hybrid temporal-utility classifications. The noted techniques are able to reduce operational load on user engagement systems by reducing the need for performing repeated/revised engagement actions, as reliable hybrid temporal-utility classifications enable selecting reliable and effective engagement actions and thus avoiding the need for repeated/revised engagement actions that would otherwise impose a substantial operational load on user engagement systems. In doing so, various embodiments of the present invention make important technical contributions to improving efficiency, effectiveness, and operational throughput of user engagement systems.

Various embodiments of the present invention provide for accurate and effective determinations for a predictive entity using a hybrid categorization of the predictive entity. In particular, a hybrid temporal-utility classification may be determined for the predictive entity such that one or more recommended engagement actions may be determined for said predictive entity. The hybrid temporal-utility classification may be based at least in part on a temporal classification as determined by a temporal classification score generation machine learning model and a utility classification as determined by a utility classification score generation machine learning model. The hybrid temporal-utility classification may serve as a unifying measure such that consideration of both broad populations which include a plurality of other predictive entities as well as consideration of the particular predictive entity of interest. As such, the one or more recommended engagement actions for the predictive entity may be customized for the predictive entity while still leveraging historical engagement action effectiveness for other predictive entities.

Various embodiments of the present invention relate to determining a predictive action to take based at least in part on a particular member’s current needs. Members who are part of a system, such as an insurance system, may consistently be targeted by different programs offered within the network based at least in part on a member’s propensity to respond or engage. However, overwhelming members with numerous and/or irrelevant campaigns for such programs may cause member abrasion. Currently, there does not exist a holistic data-driven, member-level metric available that provides direction on a next best action regarding a particular member based at least in part on the member’s needs at a particular point of time. To address this issue, a Consumer Activation Measure (CAM) is introduced as a predicted metric to better predict health outcomes, reduce healthcare costs, and improve overall member experience.

The predicted metric CAM may be determined based at least in part on two indicator type scores: a first indicator type score that is a predicted member tenure (MT) indicator type score for a member, which is indicative of a member’s likelihood to remain with the system within a duration of time, and a second indicator type score that is a predicted gross margin (GM) indicator type score for a member, which is determined based at least in part on system revenues and system costs associated with the particular member. For example, a predicted tenure indicator type score may be indicative of whether a member would stay with an organization for less than a year, more than 2 years, and/or the like. The predicted GM type score may be indicative of a system profit associated with a particular member.

The predicted level metric CAM may combine these two indicator type scores to yield a CAM score for a particular member. The CAM score may provide information regarding a member’s future and/or anticipated needs such that the member may be offered one or more programs that most closely align with the noted anticipated needs as indicated by his/her associated CAM score. For example, a CAM score may provide between 12 to 24 months advance information about a member.

In accordance with some embodiments of the present invention, an MT model may be trained. The MT model may be a trained machine learning model that is used to determine the predicted tenure type indicator scores for members which are indicative of member attrition or lapse within a duration of time. A pre-processing layer of the MT model may receive input designated for the MT model such that one or more features may be extracted by the pre-processing layer based at least in part on the input data. An example of such a feature is a member expense density feature that may be determined based at least in part on an initial period expense density value for an initial period of a total period and a terminal period expense density value for a terminal period of the terminal period. For example, a member’s medical claims over a 24-month total period may be fed into a pre-processing layer to determine a total medical expense percent using the below formula: Total Medical Expense Percent =

$$\frac{T o t a l M e d i c a l E x p e n s e i n L a s t 12 M o n t h s}{\left(T o t a l M e d i c a l E x p e n s e i n F i r s t 12 M o n t h s + 1\right)} .$$

The MT machine learning model may use an XGBoost binary classification algorithm that is to determine a final predicted tenure type indicator score as the output of the MT machine learning model. The MT machine learning model may further categorize the determined predicted tenure type indicator score for the member into two or more categories, such as low, medium, high.

In accordance with some embodiments of the present invention, a GM model may be trained. A GM model may be a machine learning model that used to determine the gross margin indicator type score indicative of a system profit associated with a particular member. The GM machine learning model may be specific to each member as it may be trained using a user’s historical data. Historical data from within a particular duration for a user may be provided as input to the GM machine learning model. The GM machine learning model may utilize at least one of (i) an auto regressive integrated moving average (ARIMA) technique and/or (ii) an unobserved component model (UCM) technique to generate one or more gross margin indicator type scores for one or more time periods. For example, a GM machine learning model may output 24 gross margin indicator type scores for each month of 24 months for a particular member. The GM machine learning model may further categorize each of the one or more gross margin indicator type scores into two or more categories, such as low, medium, high.

In accordance with some embodiments of the present invention, a CAM machine learning model may be trained. A CAM machine learning model may receive input scores from both the MT machine learning model (i.e., the predicted tenure type indicator score) and GM machine learning model (i.e., the gross margin indicator type score). The input scores may include the determined category for the predicted tenure type indicator score and the determined category for the gross margin indicator type score. The CAM machine learning model may also consider one or more additional attributes associated with a member, including attributes that are determined based at least in part on at least one of demographic information, risk adjustment factor (RAF) scores, chronic conditions, recent interactions, prior carriers, channels of acquisition, latest house call visit dates, latest primary care physician (PCP) visits, lab data, complaints, grievances, and/or the like. Based at least in part on the scores categories determined by both the MT machine learning model and the GM machine learning model, the CAM machine learning model may determine an appropriate category for the member. Based at least in part on a determined CAM score category for a member, one or more predictive actions may be determined.

For example, a CAM score may be categorized into one of two or more segments. These segments may include: (i) a CAM segment A (e.g., for low predicted tenure and high gross margin members), which may represent members with high attrition risk but high gross margin, and where members corresponding to segment A should be provided with retention program campaigns; (ii) a CAM segment B (e.g., for high predicted tenure and predicted positive gross margin members), which may include the members who are likely to be loyal members and are therefore will stay with the organization, and where members corresponding to segment B should be excluded from retention campaign programs; (iii) a CAM segment C (e.g., for low predicted tenure and predicted low/negative gross margin members), where this segment may include members with high abrasion risk and lower or negative gross margin, and where members corresponding to segment C should be targeted through other interventions such as awareness and education programs, plan change promotions, and the like because they might be potentially underutilizing their current plan; and (iv) a CAM segment D (high predicted tenure and low predicted gross margin members), which may include members with declining gross margin who are likely to stay with the organization for long, and where members corresponding to segment D should not be targeted with retention-related outbound call campaigns programs and should be offered member experience campaigns programs or clinical programs, plan change promotions, promotions related to updating their RAF scores by offering house call visits or wellness visits, and/or the like.

### II. Definitions of Certain Terms

The term “predictive entity data object” may refer to an electronically-stored data construct that is configured to describe data describing features/activities of a predictive entity (e.g., a real-world entity with respect to which one or more predictive data analysis inferences are performed) that is collected from one or more data sources. A predictive entity may be an individual, group of individuals, and/or the like. As will be recognized, a predictive entity data object may be represented as one or more vectors, embeddings, datasets, and/or the like. In some embodiments, the collected data for the predictive entity may describe demographic information, medical history, interactions with an entity of interest, prior interactions with one or more entities other than the entity of interest, channel of acquisition by the entity of interest, recent house calls, laboratory data, complaints, grievances, and/or the like.

The term “temporal classification” may refer to an electronically-stored data construct that is configured to describe a discrete measure of likelihood that a predictive data entity is associated with a non-extremal prospective period (e.g., that a member predictive entity is likely to be a member for more than one year and less than two years). For example, a lower temporal classification may describe a lowest measure of likelihood that a predictive data entity is associated with a non-extremal period, a medial temporal classification may describe a medium measure of likelihood that a predictive data entity is associated with a non-extremal period, and an upper temporal classification may describe a high measure of likelihood that a predictive data entity is associated with a non-extremal period. In some embodiments, the temporal classification is determined based at least in part on applying a temporal classification policy to a temporal classification score for a corresponding predictive entity. For example, the temporal classification score may describe a non-extremal periodicity likelihood measure for the predictive entity. The non-extremal periodicity likelihood measure may be defined based at least in part on a non-extremal prospective period. The non-extremal prospective period may be defined based at least in part on a lower extremal prospective period and an upper prospective period. In some embodiments, the lower extremal prospective period and/or upper prospective period are individually configurable by one or more end users. In some embodiments, the lower extremal prospective period and/or upper prospective period may be based at least in part on a target date, target time duration, a lower extremal bounding value, and/or an upper extremal bounding value. In some embodiments, the non-extremal prospective period is a period that is either longer than a lower threshold amount of time (e.g., more than one year), shorter than an upper threshold amount of time (e.g., less than two years), or both.

The term “utility classification” may refer to an electronically-stored data construct that is configured to describe a discrete measure of a utility measure category (e.g., a gross margin measure category) associated with a predictive entity. Examples of utility measures include a lower utility classification describing a low gross margin measure category, a medial utility classification describing a medium gross margin measure category, and an upper utility classification describing a high gross margin measure category.

The term “temporal classification input feature” may refer to a data construct that is configured to describe one or more extracted features for a predictive entity, where the temporal classification input feature may be used to determine a temporal classification for the predictive entity. In some embodiments, the pre-processing layer may process one or more numerical timeseries data fields of the predictive entity data object to transform the one or more numerical timeseries data fields in various manners. For example, the one or more numerical timeseries data fields may be processed to perform one or more mathematical and/or logical operations, such as to determine a mean, median, standard deviation, ratio, percentage, and/or the like. In some embodiments, the temporal classification input feature includes at least an entity cost density feature for the predictive entity. The entity cost density feature may correspond to a target window time period and may be based at least in part on a ratio between one or more numerical timeseries data fields within a first time frame of the target window time period to one or more numerical timeseries data fields within a second time frame of the target window time period occurring prior to the first time frame. For example, the entity cost density feature may be associated with a 24 month target window time period from today’s date and may be defined based at least in part on a ratio between the cost of a predictive entity within the first time frame which describes the last 12 months of the 24 month target window time period to the second time frame which describes the first 12 months of the 24 month target window time period.

The term “temporal classification score generation machine learning model” may refer to an electronically-stored data construct that is configured to describe parameters, hyper-parameters, and/or stored operations of a machine learning model that is configured to process one or more temporal classification input features for a predictive entity in order to determine a temporal classification for the predictive entity. In some embodiments, the temporal classification score generation model may be configured to determine the temporal classification based at least in part on one or more temporal classification input features for the predictive entity. The temporal classification score generation model may be configured to process the one or more temporal classification input features to generate a temporal classification score for the predictive entity. The temporal classification score may describe a non-extremal periodicity likelihood measure for the predictive entity. The non-extremal periodicity likelihood measure may be defined based at least in part on a non-extremal prospective period. The non-extremal prospective period may be defined based at least in part on a lower extremal prospective period and an upper prospective period. In some embodiments, the lower extremal prospective period and/or upper prospective period are individually configurable by one or more end users. In some embodiments, the lower extremal prospective period and/or upper prospective period may be based at least in part on a target date, target time duration, a lower extremal bounding value, and/or an upper extremal bounding value. The temporal classification score generation machine learning model may determine the temporal classification for the predictive entity based at least in part on the temporal classification score and a temporal classification policy. In some embodiments, the temporal classification score machine learning model may select the temporal classification from a plurality of defined temporal classifications. In some embodiments, the plurality of defined temporal classifications may include an upper temporal classification, a medial temporal classification, and a lower temporal classification. In some embodiments, the temporal classification score generation machine learning model may employ an XGBoost algorithm. In some embodiments, the parameters and/or hyper-parameters of a temporal classification score generation machine learning model may be represented as values in a one-dimensional array, such as a vector.

The term “temporal classification policy” may refer to an electronically-stored data construct that is configured to describe a set of rules and/or operations which may be used at least in part for determining which temporal classification a temporal classification score corresponds to. The temporal classification policy may be configured to describe a set of rules and/or operations which may be used at least in part for determining which temporal classification a temporal classification score corresponds to. The temporal classification policy may define one or more temporal classification categories. In some embodiments, the one or more temporal classification categories may include a lower temporal classification, medial temporal classification, and upper temporal classification category. Each temporal classification category may correspond to a particular subset of candidate temporal classification scores based at least in part on the temporal classification score for the plurality of historical predictive entities. The temporal classification policy may be defined based at least in part on a cross-entity temporal classification score distribution for a plurality of historical predictive entities. The cross-entity temporal classification score distribution may be determined based at least in part on one or more temporal classification scores for a plurality of historical predictive entities. In some embodiments, the one or more defined temporal classification categories may be based at least in part on one or more temporal classification thresholds.

The term “timeseries processing machine learning model” may refer to an electronically-stored data construct that is configured to describe parameters, hyper-parameters, and/or stored operations of a machine learning model that is configured to process a predictive entity data object to generate a forecasted timeseries data object for the corresponding predictive entity. The timeseries data object may include a plurality of per-time-unit timeseries scores for the predictive entity. Each per-time-unit timeseries score is associated with a defined timeseries time unit of a plurality of timeseries time units of a prospective time period. In some embodiments, the timeseries time unit is configurable by one or more end users. The timeseries processing machine learning model may be trained based at least in part using a timeseries processing training routine for the particular predictive entity. In some embodiments, the timeseries processing training routine may include predictive entity data within a training period window. For example, a training period window of 24 months would train the timeseries processing machine learning model using data of the predictive entity within the past 24 months. In some embodiments, the timeseries processing machine learning model is an autoregressive forecasting machine learning model. In some embodiments, the timeseries processing machine learning model is an auto regressive integrated moving average (ARIMA) machine learning model. In some embodiments, the timeseries processing model is an unobserved components model (UCM). In some embodiments, the parameters and/or hyper-parameters of a timeseries processing machine learning model may be represented as values in a two-dimensional array, such as a matrix.

The term “error-minimizing timeseries processing machine learning model” may refer to an electronically-stored data construct that is configured to describe parameters, hyper-parameters, and/or stored operations of a timeseries processing machine learning model whose generated forecasted timeseries data object has a lowest error measure with respect to a corresponding historical timeseries data object compared to the error measures of a set of timeseries processing machine learning models of a utility classification score generation machine learning model. Each timeseries data object may describe one or more per-time-unit timeseries scores for the predictive entity. The historical utility timeseries data object may describe one or more per-time-unit historical timeseries scores for the predictive entity. In some embodiments, a set of error-minimizing timeseries processing machine learning models of a utility classification score generation machine learning model (e.g., an ARIMA model and a UCM model) may each be used to generate a forecasted timeseries data object for a time period x. Then, each forecasted timeseries data object for the time period x may be compared with the historical timeseries data object for the time period x to determine an error measure for a corresponding timeseries processing machine learning model. Afterward, the timeseries processing machine learning model having the lowest error measure may be selected as the error-minimizing timeseries processing machine learning model.

The term “utility classification score generation machine learning model” may refer to an electronically-stored data construct that is configured to describe parameters, hyper-parameters, and/or stored operations of a machine learning model that is configured to process a plurality of time series data objects from one or more timeseries processing machine learning models to determine a utility classification for the predictive entity. In some embodiments, the utility classification score generation machine learning model may determine an error measure with respect to a historical utility timeseries data object associated with the predictive entity. The utility classification score generation machine learning model may generate a forecasted utility timeseries data object for the predictive entity based at least in part on an output of processing the historical utility timeseries using an error-minimizing timeseries processing machine learning model. The output of the error-minimizing timeseries processing machine learning model may be an error timeseries processing data object. The utility classification score generation machine learning model may generate the utility classification score for the predictive entity based at least in part on the forecasted utility classification timeseries data object. The utility classification score generation machine learning model may determine the utility classification based at least in part on the utility classification score and a utility classification policy. In some embodiments, the utility classification score machine learning model may select the utility classification from a plurality of defined utility classifications. In some embodiments, the plurality of defined utility classifications may include an upper utility classification, a medial utility classification, and a lower utility classification. In some embodiments, the parameters and/or hyper-parameters of a utility classification score generation machine learning model may be represented as values in a one-dimensional array, such as a vector.

The term “utility classification policy” may refer to an electronically-stored data construct that is configured to describe a set of rules and/or operations which may be used at least in part for determining which utility classification a utility classification score corresponds to. The utility classification policy may be configured to describe a set of rules and/or operations which may be used at least in part for determining which utility classification a utility classification score corresponds to. The utility classification policy may define one or more utility classification categories. In some embodiments, the one or more utility classification categories may include a lower utility classification, medial utility classification, and upper utility classification category. Each utility classification category may correspond to a particular subset of candidate utility classification scores based at least in part on the utility classification score for the plurality of historical predictive entities. The utility classification policy may be defined based at least in part on a cross-entity utility classification score distribution for a plurality of historical predictive entities. The cross-entity utility classification score distribution may be determined based at least in part on one or more utility classification scores for a plurality of historical predictive entities. In some embodiments, the one or more defined utility classification categories may be based at least in part on one or more utility classification thresholds.

The term “decision tree data object” may refer to an electronically-stored data construct that is configured to describe a decision tree model that can be used to determine one or more prediction-based actions based at least in part on a hybrid temporal-utility classification for a particular predictive entity. The decision tree data object may define a root-level node which is associated with the hybrid temporal-utility classification. Each decision tree segment may be associated with a candidate hybrid temporal-utility classification of a plurality of candidate hybrid temporal-utility classifications. The decision tree data object may additionally include one or more nodes corresponding to decision features associated each candidate hybrid temporal-utility classification segment. Each leaf-level node of the decision tree object may be associated a recommended engagement action of a plurality of candidate recommended engagement actions.

### III. Computer Program Products, Methods, and Computing Entities

Embodiments of the present invention may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware framework and/or operating system platform. A software component comprising assembly language instructions may require conversion into executable machine code by an assembler prior to execution by the hardware framework and/or platform. Another example programming language may be a higher-level programming language that may be portable across multiple frameworks. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

A computer program product may include non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present invention may also be implemented as methods, apparatuses, systems, computing devices, computing entities, and/or the like. As such, embodiments of the present invention may take the form of an apparatus, system, computing device, computing entity, and/or the like executing instructions stored on a computer-readable storage medium to perform certain steps or operations. Thus, embodiments of the present invention may also take the form of an entirely hardware embodiment, an entirely computer program product embodiment, and/or an embodiment that comprises combination of computer program products and hardware performing certain steps or operations.

Embodiments of the present invention are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

### IV. Exemplary System Framework

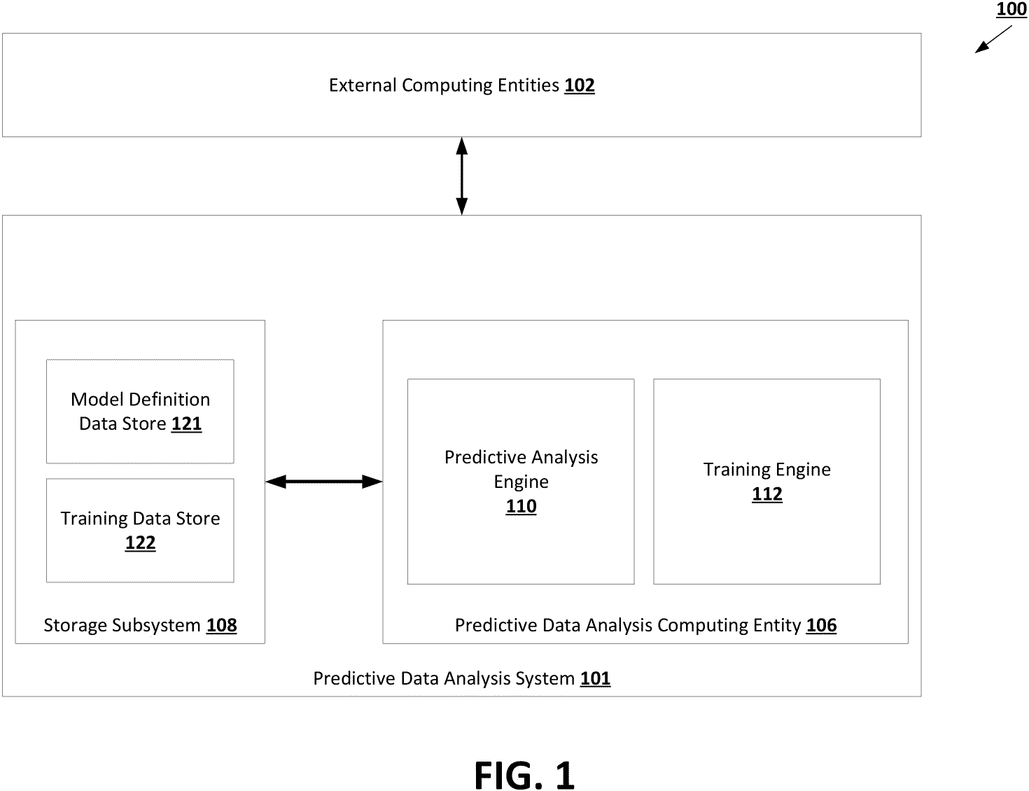

FIG. 1 is a schematic diagram of an example system architecture 100 for performing predictive data analysis operations and for performing one or more prediction-based actions (e.g., identifying one or more recommended engagement actions). The system architecture 100 includes a predictive data analysis system 101 comprising a predictive data analysis computing entity 106 configured to generate predictive outputs that can be used to perform one or more prediction-based actions. The predictive data analysis system 101 may communicate with one or more external computing entities 102 using one or more communication networks. Examples of communication networks include any wired or wireless communication network including, for example, a wired or wireless local area network (LAN), personal area network (PAN), metropolitan area network (MAN), wide area network (WAN), or the like, as well as any hardware, software and/or firmware required to implement it (such as, e.g., network routers, and/or the like). An example of a prediction that may be generated by using the system architecture 100 is to a generate predicted disease score associated with a target user depicted in a video stream data object.

The system architecture 100 includes a storage subsystem 108 configured to store at least a portion of the data utilized by the predictive data analysis system 101. The predictive data analysis computing entity 106 may be in communication with one or more external computing entities 102. The predictive data analysis computing entity 106 may be configured to train a prediction model (e.g., one or more of temporal classification score generation machine learning models, utility classification score generation machine learning models, timeseries processing machine learning models, error-minimizing timeseries processing machine learning model) based at least in part on the training data store 122 stored in the storage subsystem 108, store trained prediction models as part of the model definition data store 121 stored in the storage subsystem 108, utilize trained models to generate predictions based at least in part on prediction inputs provided by an external computing entity 102, and perform prediction-based actions based at least in part on the generated predictions. The storage subsystem may be configured to store the model definition data store 121 for one or more predictive data analysis models and the training data store 122 uses to train one or more predictive data analysis models. The predictive data analysis computing entity 106 may be configured to receive requests and/or data from external computing entities 102, process the requests and/or data to generate predictive outputs (e.g., one or more recommended engagement actions), and provide the predictive outputs to the external computing entities 102. The external computing entity 102 may periodically update/provide raw input data (e.g., predictive entity data object) to the predictive data analysis system 101. The external computing entities 102 may further generate user interface data (e.g., one or more hybrid temporal-utility classification summary data object) corresponding to the predictive outputs and may provide (e.g., transmit, send and/or the like) the user interface data corresponding with the predictive outputs for presentation to user computing entities operated by end-users.

The storage subsystem 108 may be configured to store at least a portion of the data utilized by the predictive data analysis computing entity 106 to perform predictive data analysis steps/operations and tasks. The storage subsystem 108 may be configured to store at least a portion of operational data and/or operational configuration data including operational instructions and parameters utilized by the predictive data analysis computing entity 106 to perform predictive data analysis steps/operations in response to requests. The storage subsystem 108 may include one or more storage units, such as multiple distributed storage units that are connected through a computer network. Each storage unit in the storage subsystem 108 may store at least one of one or more data assets and/or one or more data about the computed properties of one or more data assets. Moreover, each storage unit in the storage subsystem 108 may include one or more non-volatile storage or memory media including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

The predictive data analysis computing entity 106 includes a predictive data analysis engine 110 and a training engine 112. The predictive data analysis engine 110 may be configured to perform predictive data analysis based at least in part on a received user feature data object. For example, the predictive data analysis engine 110 may be configured to one or more prediction based actions based at least in part on a fall likelihood prediction. The training engine 112 may be configured to train the predictive data analysis engine 110 in accordance with the training data store 122 stored in the storage subsystem 108.

### Exemplary Predictive Data Analysis Computing Entity

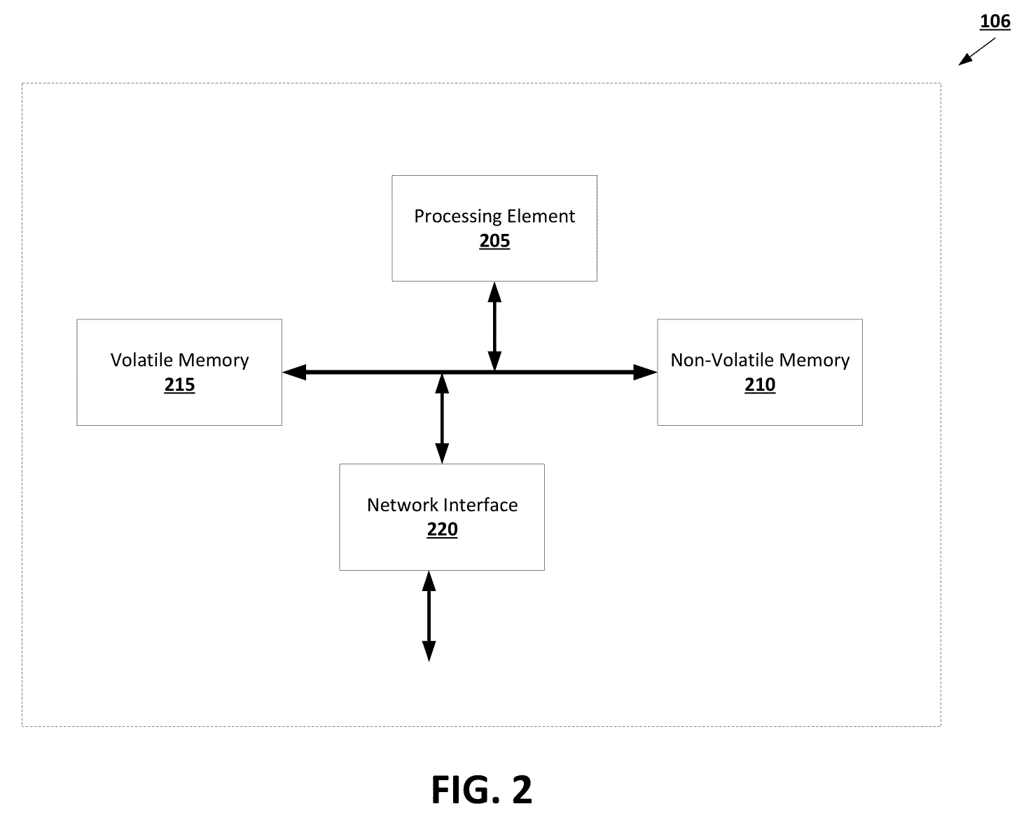

FIG. 2 provides a schematic of a predictive data analysis computing entity 106 according to one embodiment of the present invention. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, steps/operations, and/or processes described herein. Such functions, steps/operations, and/or processes may include, for example, transmitting, receiving, operating on, processing, displaying, storing, determining, creating/generating, monitoring, evaluating, comparing, and/or similar terms used herein interchangeably. In one embodiment, these functions, steps/operations, and/or processes can be performed on data, content, information, and/or similar terms used herein interchangeably.

As indicated, in one embodiment, the predictive data analysis computing entity 106 may also include a network interface 220 for communicating with various computing entities, such as by communicating data, content, information, and/or similar terms used herein interchangeably that can be transmitted, received, operated on, processed, displayed, stored, and/or the like.

As shown in FIG. 2, in one embodiment, the predictive data analysis computing entity 106 may include or be in communication with a processing element 205 (also referred to as processors, processing circuitry, and/or similar terms used herein interchangeably) that communicate with other elements within the predictive data analysis computing entity 106 via a bus, for example. As will be understood, the processing element 205 may be embodied in a number of different ways.

For example, the processing element 205 may be embodied as one or more complex programmable logic devices (CPLDs), microprocessors, multi-core processors, coprocessing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present invention when configured accordingly.

In one embodiment, the predictive data analysis computing entity 106 may further include or be in communication with non-volatile media (also referred to as non-volatile storage, memory, memory storage, memory circuitry and/or similar terms used herein interchangeably). In one embodiment, the non-volatile storage or memory may include at least one non-volatile memory 210, including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

As will be recognized, the non-volatile storage or memory media may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

In one embodiment, the predictive data analysis computing entity 106 may further include or be in communication with volatile media (also referred to as volatile storage, memory, memory storage, memory circuitry and/or similar terms used herein interchangeably). In one embodiment, the volatile storage or memory may also include at least one volatile memory 215, including but not limited to RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like.

As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 205. Thus, the databases, database instances, database management systems, data, applications, programs, program modules, scripts, source code, object code, byte code, compiled code, interpreted code, machine code, executable instructions, and/or the like may be used to control certain aspects of the operation of the predictive data analysis computing entity 106 with the assistance of the processing element 205 and operating system.

As indicated, in one embodiment, the predictive data analysis computing entity 106 may also include a network interface 220 for communicating with various computing entities, such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the predictive data analysis computing entity 106 may be configured to communicate via wireless client communication networks using any of a variety of protocols, such as general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the predictive data analysis computing entity 106 may include or be in communication with one or more input elements, such as a keyboard input, a mouse input, a touch screen/display input, motion input, movement input, audio input, pointing device input, joystick input, keypad input, and/or the like. The predictive data analysis computing entity 106 may also include or be in communication with one or more output elements (not shown), such as audio output, video output, screen/display output, motion output, movement output, and/or the like.

### Exemplary External Computing Entity

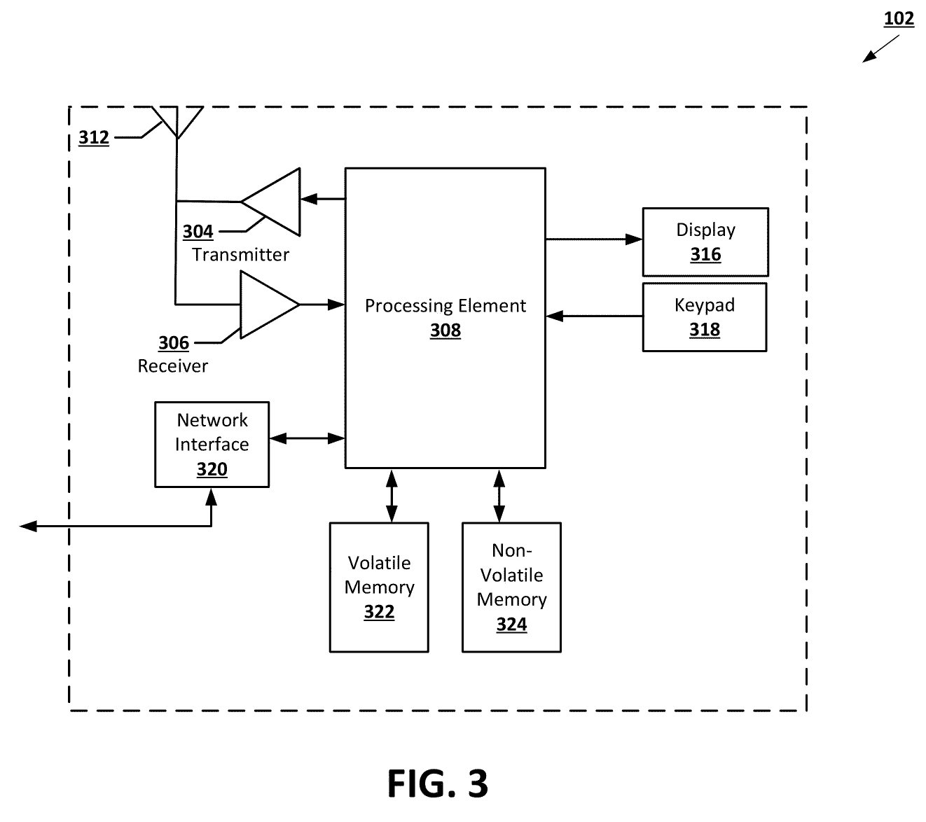

FIG. 3 provides an illustrative schematic representative of an external computing entity 102 that can be used in conjunction with embodiments of the present invention. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, steps/operations, and/or processes described herein. External computing entities 102 can be operated by various parties. As shown in FIG. 3, the external computing entity 102 can include an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may include signaling information/data in accordance with air interface standards of applicable wireless systems. In this regard, the external computing entity 102 may be capable of operating with one or more air interface standards, communication protocols, modulation types, and access types. More particularly, the external computing entity 102 may operate in accordance with any of a number of wireless communication standards and protocols, such as those described above with regard to the predictive data analysis computing entity 106. In a particular embodiment, the external computing entity 102 may operate in accordance with multiple wireless communication standards and protocols, such as UMTS, CDMA2000, 1xRTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the external computing entity 102 may operate in accordance with multiple wired communication standards and protocols, such as those described above with regard to the predictive data analysis computing entity 106 via a network interface 320.

Via these communication standards and protocols, the external computing entity 102 can communicate with various other entities using concepts such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The external computing entity 102 can also download changes, add-ons, and updates, for instance, to its firmware, software (e.g., including executable instructions, applications, program modules), and operating system.

According to one embodiment, the external computing entity 102 may include location determining aspects, devices, modules, functionalities, and/or similar words used herein interchangeably. For example, the external computing entity 102 may include outdoor positioning aspects, such as a location module adapted to acquire, for example, latitude, longitude, altitude, geocode, course, direction, heading, speed, universal time (UTC), date, and/or various other information/data. In one embodiment, the location module can acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data can be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data can be determined by triangulating the external computing entity’s 102 position in connection with a variety of other systems, including cellular towers, Wi-Fi access points, and/or the like. Similarly, the external computing entity 102 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops) and/or the like. For instance, such technologies may include the iBeacons, Gimbal proximity beacons, Bluetooth Low Energy (BLE) transmitters, NFC transmitters, and/or the like. These indoor positioning aspects can be used in a variety of settings to determine the location of someone or something to within inches or centimeters.

The external computing entity 102 may also comprise a user interface (that can include a display 316 coupled to a processing element 308) and/or a user input interface (coupled to a processing element 308). For example, the user interface may be a user application, browser, user interface, and/or similar words used herein interchangeably executing on and/or accessible via the external computing entity 102 to interact with and/or cause display of information/data from the predictive data analysis computing entity 106, as described herein. The user input interface can comprise any of a number of devices or interfaces allowing the external computing entity 102 to receive data, such as a keypad 318 (hard or soft), a touch display, voice/speech or motion interfaces, or other input device. In embodiments including a keypad 318, the keypad 318 can include (or cause display of) the conventional numeric (0-9) and related keys (#, *), and other keys used for operating the external computing entity 102 and may include a full set of alphabetic keys or set of keys that may be activated to provide a full set of alphanumeric keys. In addition to providing input, the user input interface can be used, for example, to activate or deactivate certain functions, such as screen savers and/or sleep modes.

The external computing entity 102 can also include volatile storage or memory 322 and/or non-volatile storage or memory 324, which can be embedded and/or may be removable. For example, the non-volatile memory may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile storage or memory can store databases, database instances, database management systems, data, applications, programs, program modules, scripts, source code, object code, byte code, compiled code, interpreted code, machine code, executable instructions, and/or the like to implement the functions of the external computing entity 102. As indicated, this may include a user application that is resident on the entity or accessible through a browser or other user interface for communicating with the predictive data analysis computing entity 106 and/or various other computing entities.

In another embodiment, the external computing entity 102 may include one or more components or functionality that are the same or similar to those of the predictive data analysis computing entity 106, as described in greater detail above. As will be recognized, these frameworks and descriptions are provided for exemplary purposes only and are not limiting to the various embodiments.

In various embodiments, the external computing entity 102 may be embodied as an artificial intelligence (AI) computing entity, such as an Amazon Echo, Amazon Echo Dot, Amazon Show, Google Home, and/or the like. Accordingly, the external computing entity 102 may be configured to provide and/or receive information/data from a user via an input/output mechanism, such as a display, a video capture device (e.g., camera), a speaker, a voice-activated input, and/or the like. In certain embodiments, an AI computing entity may comprise one or more predefined and executable program algorithms stored within an onboard memory storage module, and/or accessible over a network. In various embodiments, the AI computing entity may be configured to retrieve and/or execute one or more of the predefined program algorithms upon the occurrence of a predefined trigger event.

### V. Exemplary System Operations

Provided below are exemplary techniques for generating a hybrid temporal-utility classification which may be used to perform one or more predictive inferences. However, while various embodiments of the present invention describe the model generation operations described herein and the predictive inference operations described herein as being performed by the same single computing entity, a person of ordinary skill in the relevant technology will recognize that each of the noted sets of computer-implemented operations described herein can be performed by one or more computing entities that may be the same as or different from the one or more computing entities used to perform each of the other sets of computer-implemented operations described herein.

As described below, various embodiments of the present invention improve the accuracy and effectiveness of determinations for a predictive entity using a hybrid categorization of the predictive entity. In some embodiments, one advantage of determining a hybrid categorization for a predictive entity is the consideration of both broad populations which include a plurality of other predictive entities as well as consideration of the particular predictive entity of interest. Therefore, the one or more predictive actions determined for the predictive entity may be customized for the predictive entity while still leveraging historical engagement action effectiveness for other predictive entities. Furthermore, performing the one or more predictive actions may result in increased satisfaction and reduced abrasion of the predictive entity.

Moreover, various embodiments of the present invention introduce techniques for targeting engagement actions based at least in part on reliable hybrid temporal-utility classifications. The noted techniques are able to reduce operational load on user engagement systems by reducing the need for performing repeated/revised engagement actions, as reliable hybrid temporal-utility classifications enable selecting reliable and effective engagement actions and thus avoiding the need for repeated/revised engagement actions that would otherwise impose a substantial operational load on user engagement systems. In doing so, various embodiments of the present invention make important technical contributions to improving efficiency, effectiveness, and operational throughput of user engagement systems.

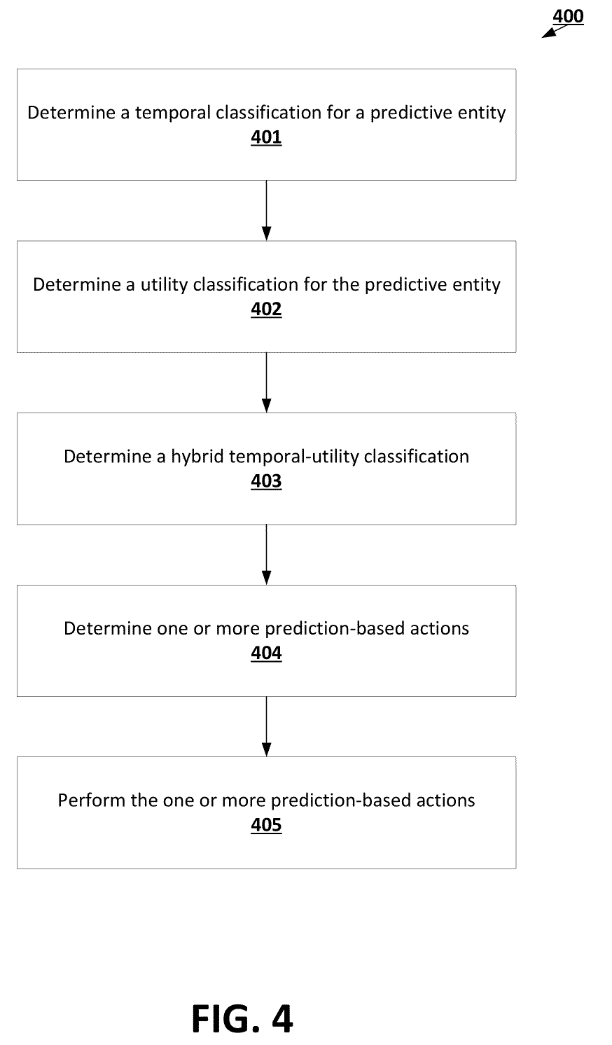

FIG. 4 is a flowchart diagram of an example process 400 for determining a hybrid temporal-utility classification for a predictive entity. Via the various steps/operations of the process 400, the predictive data analysis computing entity 106 can dynamically determine the hybrid temporal-utility classification and one or more prediction-based actions based at least in part on the determined hybrid temporal-utility classification.

The process 400 begins at step/operation 401 when the predictive data analysis engine 110 of the predictive data analysis computing entity 106 determines a temporal classification for a predictive entity. In some embodiments, the predictive data analysis engine 110 receives a predictive entity data object from one or more external computing entities 102. In some embodiments, receipt of the predictive entity data object may automatically trigger the predictive data analysis engine 110 to perform the one or more step/operations as described in FIG. 4. The predictive entity data object may describe data describing features/activities of a predictive entity that is collected from one or more data sources. A predictive entity may be an individual, group of individuals, and/or the like. As will be recognized, a predictive entity data object may be represented as one or more vectors, embeddings, datasets, and/or the like. In some embodiments, the collected data for the predictive entity may describe demographic information, medical history, interactions with an entity of interest, prior interactions with one or more entities other than the entity of interest, channel of acquisition by the entity of interest, recent house calls, laboratory data, complaints, grievances, and/or the like.

In some embodiments, the predictive data analysis engine 110 may use a temporal classification score generation machine learning model to generate one or more temporal classification input features. In some embodiments, the temporal classification score generation machine learning model may be configured to use a pre-processing layer to extract one or more features from the predictive entity data object to generate the one or more temporal classification input features. In some embodiments, the pre-processing layer may process one or more numerical timeseries data fields of the predictive entity data object to transform the one or more numerical timeseries data fields in various manners. For example, the one or more numerical timeseries data fields may be processed to perform one or more mathematical and/or logical operations, such as to determine a mean, median, standard deviation, ratio, percentage, and/or the like. In some embodiments, the temporal classification input feature includes at least an entity cost density feature for the predictive entity. The entity cost density feature may correspond to a target window time period and may be based at least in part on a ratio between one or more numerical timeseries data fields within a first time frame of the target window time period to one or more numerical timeseries data fields within a second time frame of the target window time period occurring prior to the first time frame. For example, the entity cost density feature may be associated with a 24 month target window time period from today’s date and may be defined based at least in part on a ratio between the cost of a predictive entity within the first time frame which describes the last 12 months of the 24 month target window time period to the second time frame which describes the first 12 months of the 24 month target window time period. The pre-processing layer may determine the entity cost density feature using the below equation:

$$E n t i t y C o s t D e n s i t y = \frac{p r e d i c t i v e e n t i t y c o s t w i t h i n l a s t 12 m o n t h s}{\left(p r e d i c t i v i t y e n t i t y c o s t w i t h i n f i r s t 12 m o n t h s + 1\right)}$$

In Equation 1 and/or other embodiments of determining an entity cost density feature described herein, an example of a cost measure and/or of a predictive entity cost is a total medical expense measure for a corresponding period for a corresponding member/patient predictive data entity.

The predictive data analysis engine 110 may use a temporal classification score generation machine learning model to determine the temporal classification for the predictive entity. The temporal classification score generation machine learning model may be configured to process a predictive entity data object in order to determine a temporal classification for the predictive entity. The temporal classification score generation model may be configured to process the one or more temporal classification input features to generate a temporal classification score for the predictive entity. In some embodiments, the temporal classification score generation machine learning model may employ an XGBoost algorithm. The temporal classification score may describe a non-extremal periodicity likelihood measure for the predictive entity. The non-extremal periodicity likelihood measure may be defined based at least in part on a non-extremal prospective period. The non-extremal prospective period may be defined based at least in part on a lower extremal prospective period and an upper prospective period. In some embodiments, the lower extremal prospective period and/or upper prospective period are individually configurable by one or more end users. In some embodiments, the lower extremal prospective period and/or upper prospective period may be based at least in part on a target date, target time duration, a lower extremal bounding value, and/or an upper extremal bounding value. For example, a non-extremal prospective period may be defined based at least in part on a target date of Jan. 1, 2018 and a target time duration of 2 years. As such, a lower extremal bounding value of Jan. 1, 2018 and an upper extremal bounding value of Dec. 31, 2020 may be defined. Therefore, a lower extremal prospective period may be defined as any date prior to Jan. 1, 2018 (e.g., Dec. 31, 2017 and prior), an upper extremal prospective period may be defined as any date after Dec. 31, 2020 (e.g., Jan. 1, 2021 and onward), and a non-extremal prospective period may be defined as the time period ranging between the dates of Jan. 1, 2018 to Dec. 31, 2020.

The temporal classification score generation machine learning model may then determine the temporal classification for the predictive entity based at least in part on the temporal classification score and a temporal classification policy. The temporal classification policy may be configured to describe a set of rules and/or operations which may be used at least in part for determining which temporal classification a temporal classification score corresponds to. The temporal classification policy may define one or more temporal classification categories. In some embodiments, the one or more temporal classification categories may include a lower temporal classification, medial temporal classification, and upper temporal classification category. Each temporal classification category may correspond to a particular subset of candidate temporal classification scores based at least in part on the temporal classification score for the plurality of historical predictive entities. The temporal classification policy may be defined based at least in part on a cross-entity temporal classification score distribution for a plurality of historical predictive entities. The cross-entity temporal classification score distribution may be determined based at least in part on one or more temporal classification scores for a plurality of historical predictive entities. In some embodiments, the one or more defined temporal classification categories may be based at least in part on one or more temporal classification thresholds.

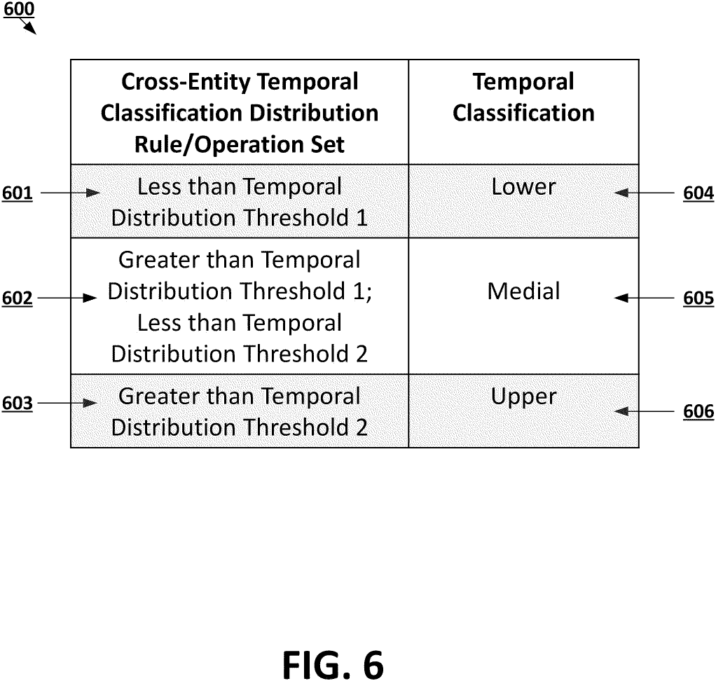

FIG. 6 depicts an operational example of a temporal classification policy 600 in accordance with some embodiments. The temporal classification policy may include a lower temporal classification category 604, a medial temporal classification category 605, and upper temporal classification category 606. Each temporal classification category may be defined by a set of rules and/or operations. Here, the lower temporal classification category is defined by a lower rule set 601, the medial temporal classification category is defined by a medial rule set 602, and the upper temporal classification category is defined by an upper rule set 603. The corresponding temporal classification scores corresponding to each temporal classification category may be based at least in part on a cross-entity temporal classification score distribution for a plurality of historical predictive entities. For example, a cross-entity temporal classification score distribution may include 100 temporal classification scores each corresponding to a particular historical predictive entity. A temporal classification threshold may include a less than 20% threshold and greater than 80% threshold such that the lower temporal classification category includes temporal classification scores inclusively within the bottom 20% of the plurality of temporal classification scores, the medial temporal classification category includes temporal classification scores between 21% and 79% of the plurality of temporal classification scores, and the upper temporal classification category includes temporal classification scores inclusively in the top 20%. The 100 temporal classification scores may be evaluated by the predictive data analysis engine 110 to determine the corresponding temporal classification score ranges for each temporal classification category.

Returning now to FIG. 4, in some embodiments, the temporal classification score generation machine learning model may select the temporal classification from a plurality of defined temporal classifications based at least in part on the temporal classification score and the temporal classification policy. In some embodiments, the plurality of defined temporal classifications may include an upper temporal classification, a medial temporal classification, and a lower temporal classification. For example, a temporal classification policy may define a lower temporal classification category of temporal classification scores ranging between 0-0.25, a medial temporal classification category of temporal classification scores ranging between 0.26-0.75, and an upper temporal classification category of temporal classification scores ranging between 0.76-1. The temporal classification score generation machine learning model may determine the temporal classification category with which the temporal classification score corresponds. By way of continuing example, the temporal classification score generation machine learning model may determine a temporal classification score of 0.4 corresponds to a medial temporal classification category. In some embodiments, the parameters and/or hyper-parameters of the temporal classification score generation machine learning model may be represented as values in a one-dimensional array, such as a vector.

At step/operation 402, the predictive data analysis engine 110 of the predictive data analysis computing entity 106 determines a utility classification for the predictive entity. In some embodiments, the predictive data analysis engine 110 may use a utility classification score generation machine learning model to determine the utility classification for the predictive entity. The utility classification score generation machine learning model may be configured to receive one or more time series data objects from one or more timeseries processing machine learning models. The utility classification score generation machine learning model may be configured to process the one or more time series data objects to generate a forecasted utility classification timeseries data object based at least in part on the output of an error-minimizing timeseries processing machine learning model. The utility classification score generation machine learning model may generate a utility classification score for the predictive entity based at least in part on the forecasted utility classification timeseries data object. The utility classification score generation machine learning model may determine the utility classification for the predictive entity based at least in part on the utility classification score and a utility classification policy. In some embodiments, the parameters and/or hyper-parameters of the utility classification score generation machine learning model may be represented as values in a one-dimensional array, such as a vector.

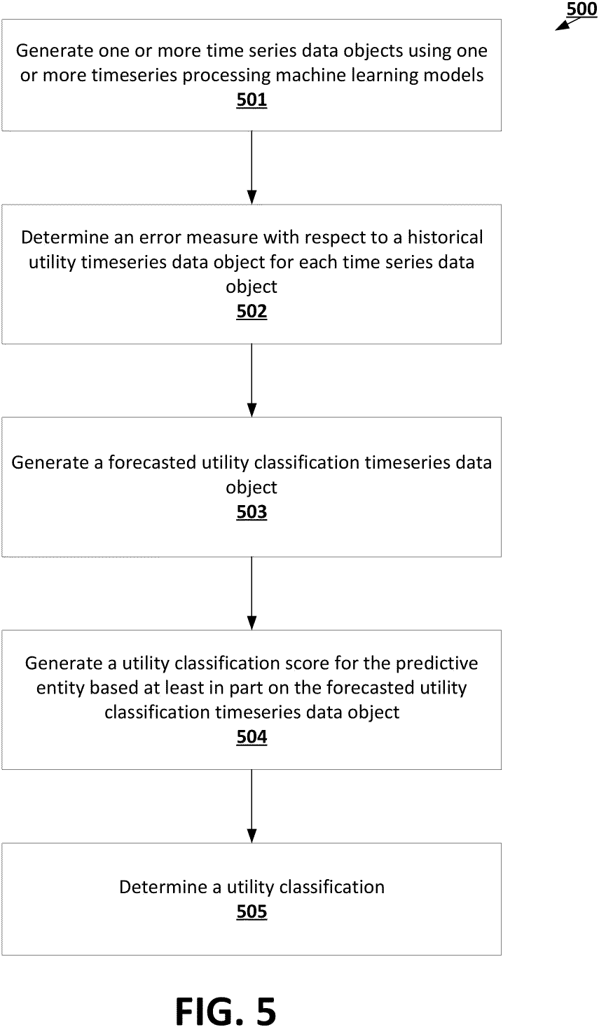

In some embodiments, step/operation 402 may be performed in accordance with the various steps/operations of the process 500 depicted in FIG. 5, which is a flowchart diagram of an example process for determining a utility classification for a predictive entity.

The process begins at step/operation 501 when the predictive data analysis engine 110 of the predictive data analysis computing entity 106 generates one or more timeseries data objects using one or more timeseries processing machine learning models. Each timeseries processing machine learning model may be configured to process a predictive entity data object to generate a forecasted timeseries data object. The timeseries data object may include a plurality of per-time-unit timeseries scores for the predictive entity for a particular prospective time period. Each per-time-unit timeseries score is associated with a defined timeseries time unit of a plurality of timeseries time units of a prospective time period. In some embodiments, the timeseries time unit is configurable by one or more end users. For example, a defined timeseries time unit may be defined as monthly. As such, a timeseries data object associated within a prospective time period of 2 years may have 24 per-time-unit timeseries scores each corresponding to a particular month within the 2 year range.

The timeseries processing machine learning model may be trained based at least in part using a timeseries processing training routine for the particular predictive entity. The timeseries processing training routine may be performed by training engine 112 using training data from training data store 122. The training data may include historical predictive entity data corresponding to the particular predictive entity. In some embodiments, the timeseries processing training routine may include historical predictive entity data within a training period window. For example, a training period window of 24 months would train the timeseries processing machine learning model using historical predictive entity data corresponding to the predictive entity within the past 24 months. As such, the timeseries processing machine learning model may be trained using predictive entity specific data such that the timeseries processing machine learning model is customized for the particular predictive entity.

In some embodiments, the timeseries processing machine learning model is an autoregressive forecasting machine learning model. In some embodiments, the timeseries processing machine learning model is an auto regressive integrated moving average (ARIMA) machine learning model. In some embodiments, the timeseries processing model is an unobserved components model (UCM). In some embodiments, the parameters and/or hyper-parameters of a timeseries processing machine learning model may be represented as values in a two-dimensional array, such as a matrix.

At step/operation 502, the predictive data analysis engine 110 of the predictive data analysis computing entity 106 determines an error measure with respect to a historical utility timeseries data object for each time series data object. The predictive data analysis engine 110 may use the utility score generation machine learning model to determine the error measure. In some embodiments, the utility score generation machine learning model may use an error-minimizing timeseries processing machine learning model to determine the error measure. The historical utility timeseries data object may be a previously generated utility timeseries data object for the particular predictive entity and may be associated with a historical predictive entity input feature. The historical utility timeseries data object may be associated with one or more ground-truth utility timeseries data values. In some embodiments, the historical utility timeseries data object may be stored in training data store 122. The error-minimizing timeseries processing machine learning model may be configured to provide the historical predictive entity input feature to the one or more timeseries processing machine learning models used to generate the one or more timeseries data objects. The error-minimizing timeseries processing machine learning model may determine an associated error measure for each of the one or more timeseries processing machine learning models. The associated error measure may be based at least in part on the similarity between the timeseries data object output by the particular timeseries processing machine learning model using the historical predictive entity input feature and the historical utility timeseries data object. The utility score generation machine learning model may generate an error timeseries processing data object. The error timeseries processing data object may describe the one or more determined error measures corresponding to the particular timeseries processing machine learning models of the one or more timeseries processing machine learning models.

At step/operation 503, the predictive data analysis engine 110 of the predictive data analysis computing entity 106 generates a forecasted utility classification timeseries data object. The predictive data analysis engine 110 may use a utility score generation machine learning model to generate the forecasted utility classification timeseries data object. The utility score generation machine learning model may generate the forecasted utility classification timeseries data object based at least in part on the error timeseries processing data object. The utility score generation machine learning model may process the error timeseries processing data object to determine the timeseries processing machine learning model with the lowest associated error measure. The utility score generation machine learning model may then generate the forecasted utility classification timeseries data object based at least in part on the timeseries data object generated by the timeseries processing machine learning model associated with the lowest error measure. In some embodiments, the forecasted utility classification timeseries data object is the timeseries data object as generated by the timeseries processing machine learning model associated with the lowest error measure.

At step/operation 504, the predictive data analysis engine 110 of the predictive data analysis computing entity 106 generates a utility classification score for the predictive entity. In some embodiments, the predictive data analysis engine 110 generates the utility classification score using the utility score generation machine learning model. The utility classification score generation machine learning model may generate the utility classification score for the predictive entity based at least in part on the forecasted utility classification timeseries data object. In some embodiments, the forecasted utility classification timeseries data object may include a plurality of per-time-unit classification scores for the predictive entity. Each per-time-unit timeseries score is associated with a defined timeseries time unit of a plurality of timeseries time units of a prospective time period. For example, a defined timeseries time unit may be defined as monthly. As such, a forecasted utility data object associated within a prospective time period of 2 years may have 24 per-time-unit timeseries scores each corresponding to a particular month within the 2 year range.

In some embodiments, the utility classification score generation machine learning model may generate the utility classification score based at least in part on each per-time-unit utility classification score. In some embodiments, the utility classification score generation machine learning model may perform one or more mathematical and/or logical operations on the plurality of per-time-unit utility classification scores to generate a utility classification score. For example, the utility classification score generation machine learning model may average the plurality of per-time-unit utility classification scores to generate the utility classification score.

At step/operation 505, the predictive data analysis engine 110 of the predictive data analysis computing entity 106 determines a utility classification. In some embodiments, the predictive data analysis engine 110 uses the utility classification score generation machine learning model to determine the utility classification.

The utility classification score generation machine learning model may determine the utility classification for the predictive entity based at least in part on the utility classification score and a utility classification policy. The utility classification policy may be configured to describe a set of rules and/or operations which may be used at least in part for determining which utility classification a utility classification score corresponds to. The utility classification policy may define one or more utility classification categories. In some embodiments, the one or more utility classification categories may include a lower utility classification, medial utility classification, and upper utility classification category. Each utility classification category may correspond to a particular subset of candidate utility classification scores based at least in part on the utility classification score for the plurality of historical predictive entities. The utility classification policy may be defined based at least in part on a cross-entity utility score distribution for a plurality of historical predictive entities. The cross-entity utility classification score distribution may be determined based at least in part on one or more utility classification scores for a plurality of historical predictive entities. In some embodiments, the one or more defined utility classification categories may be based at least in part on one or more utility classification thresholds.

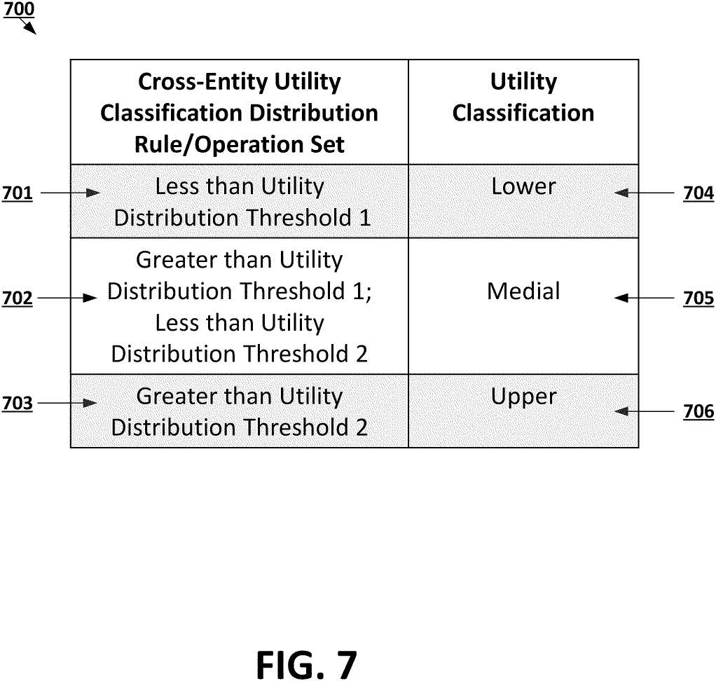

FIG. 7 depicts an operational example of a utility classification policy 700 in accordance with some embodiments. The utility classification policy may include a lower utility classification category 704, a medial utility classification category 705, and upper utility classification category 706. Each utility classification category may be defined by a set of rules and/or operations. Here, the lower utility classification category is defined by a lower rule set 701, the medial utility classification category is defined by a medial rule set 702, and the upper utility classification category is defined by an upper rule set 703. The corresponding utility classification scores corresponding to each utility classification category may be based at least in part on a cross-entity utility score distribution for a plurality of historical predictive entities. For example, a cross-entity utility classification score distribution may include 100 utility classification scores each corresponding to a particular historical predictive entity. A utility classification threshold may include a less than 20% threshold and greater than 80% threshold such that the lower utility classification category includes utility classification scores inclusively within the bottom 20% of the plurality of utility classification scores, the medial utility classification category includes utility classification scores between 21% and 79% of the plurality of utility classification scores, and the upper utility classification category includes utility classification scores inclusively in the top 20%. The 100 utility classification scores may be evaluated by the predictive data analysis engine 110 to determine the corresponding utility classification score ranges for each utility classification category.

Returning now to FIG. 5, in some embodiments, the utility classification score generation machine learning model may select the utility classification from a plurality of defined utility classifications based at least in part on the utility classification score and the utility classification policy. In some embodiments, the plurality of defined utility classifications may include an upper utility classification, a medial utility classification, and a lower utility classification. For example, a utility classification policy may define a lower utility classification category of utility classification scores ranging between 0-0.25, a medial utility classification category of utility classification scores ranging between 0.26-0.75, and an upper utility classification category of utility classification scores ranging between 0.76-1. The utility classification score generation machine learning model may determine the utility classification category with which the utility classification score corresponds. By way of continuing example, the utility classification score generation machine learning model may determine a utility classification score of 0.2 corresponds to a lower utility classification category.

Returning now to FIG. 4, at step/operation 403, the predictive data analysis engine 110 of the predictive data analysis computing entity 106 determines a hybrid temporal-utility classification for the predictive entity. The predictive data analysis engine 110 may determine the hybrid temporal-utility classification for the predictive entity based at least in part on the temporal classification and the utility classification as determined in step/operations 401 and 402, respectively.

Using the step/operation 403, various embodiments of the present invention introduce techniques for targeting engagement actions based at least in part on reliable hybrid temporal-utility classifications. The noted techniques are able to reduce operational load on user engagement systems by reducing the need for performing repeated/revised engagement actions, as reliable hybrid temporal-utility classifications enable selecting reliable and effective engagement actions and thus avoiding the need for repeated/revised engagement actions that would otherwise impose a substantial operational load on user engagement systems. In doing so, various embodiments of the present invention make important technical contributions to improving efficiency, effectiveness, and operational throughput of user engagement systems.

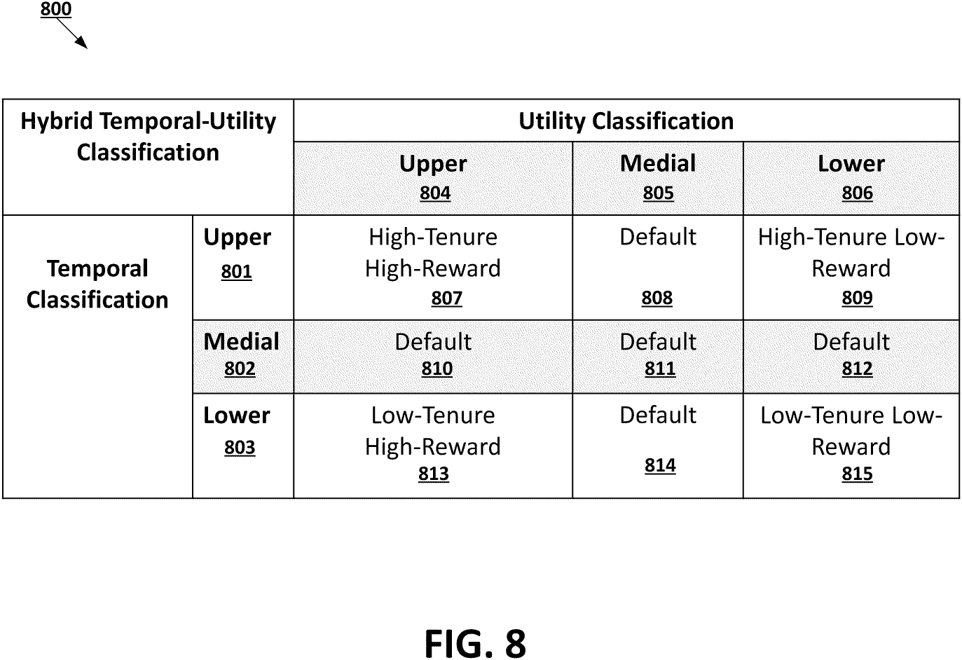

An operational example of a hybrid temporal-utility classification determination 800 is depicted in FIG. 8. The hybrid temporal-utility classification may be based at least in part on both a temporal classification and utility classification. In some embodiments, in response to the predictive data analysis engine 110 determining that a temporal classification corresponds to the upper temporal classification 801 and the utility classification corresponds to a lower utility classification 806, the predictive data analysis engine 110 determine the hybrid temporal-utility classification is a high-tenure low-reward temporal-utility classification 809. In some embodiments, in response to the predictive data analysis engine 110 determining that a temporal classification corresponds to the lower temporal classification 803 and the utility classification corresponds to a lower utility classification 806, the predictive data analysis engine 110 determine the hybrid temporal-utility classification is a low-tenure low-reward temporal-utility classification 815. In some embodiments, in response to the predictive data analysis engine 110 determining that a temporal classification corresponds to the lower temporal classification 803 and the utility classification corresponds to a upper utility classification 804, the predictive data analysis engine 110 determine the hybrid temporal-utility classification is a low-tenure high-reward temporal-utility classification 813. In some embodiments, in response to the predictive data analysis engine 110 determining that a temporal classification corresponds to the upper temporal classification 801 and the utility classification corresponds to a upper utility classification 804, the predictive data analysis engine 110 determine the hybrid temporal-utility classification is a high-tenure high-reward temporal-utility classification 807. In some embodiments, in response to the predictive data analysis engine 110 determining that a temporal classification corresponds to the medial temporal classification 802, the predictive data analysis engine 110 determine the hybrid temporal-utility classification is a default temporal-utility classification 810, 811, and 812. In some embodiments, in response to the predictive data analysis engine 110 determining that a utility classification corresponds to the medial utility classification 805, the predictive data analysis engine 110 determines the hybrid temporal-utility classification is a default temporal-utility classification 808, 811, and 814.

Returning now to FIG. 4, at step/operation 404, the predictive data analysis engine 110 of the predictive data analysis computing entity 106 determines one or more prediction-based actions. In some embodiments, the predictive data analysis engine 110 may determine one or more prediction-based actions based at least in part by using a decision tree data object. The decision tree data object may define a root-level node which is associated with the hybrid temporal-utility classification. Each decision tree segment may be associated with a candidate hybrid temporal-utility classification of a plurality of candidate hybrid temporal-utility classifications. The decision tree data object may additionally include one or more nodes corresponding to decision features associated each candidate hybrid temporal-utility classification segment. A leaf-level node of the decision tree object may be associated a recommended engagement action of a plurality of candidate recommended engagement actions.

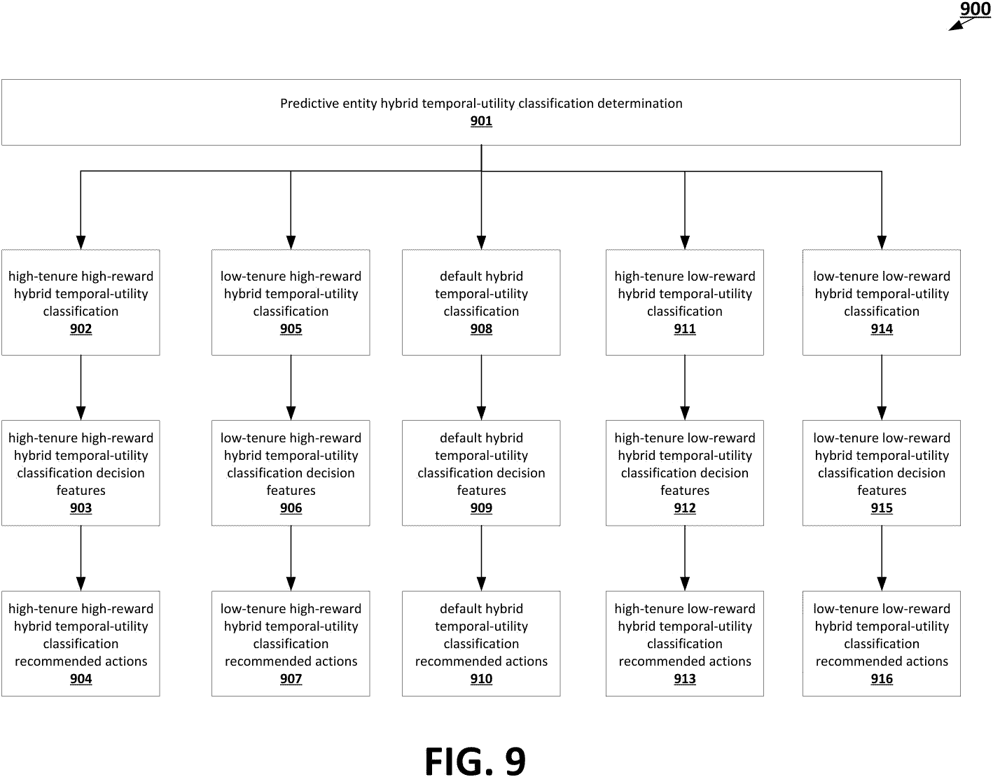

FIG. 9 depicts an operational example of a decision tree data object 900. The root-level node 901 corresponds to the hybrid temporal-utility classification for the predictive entity as determined in step/operation 403 of FIG. 4. The predictive data analysis engine 110 may traverse the decision tree based at least in part on the hybrid temporal-utility classification such that the decision tree segment that is traversed corresponds to the hybrid temporal-utility classification for the predictive entity. The decision tree may have nodes 902, 905, 908, 911, and 914 corresponding to hybrid temporal-utility classifications respectively, and nodes 903, 906, 909, 912, 915 corresponding to decision features respectively. Although a single decision feature node is shown in FIG. 9, each hybrid temporal-utility classification may have two or more decision feature nodes. Furthermore, each decision node may further split into two or more decision nodes. A decision node may be based at least in part on one or more features from the predictive entity data object, such as, for example, demographic information, medical history, interactions with an entity of interest, prior interactions with one or more entities other than the entity of interest, channel of acquisition by the entity of interest, recent house calls, laboratory data, complaints, grievances, and/or the like. The predictive data analysis engine 110 may continue to select the decision feature nodes until a leaf-level node is reached. The leaf level node may describe one or more recommended engagement actions for the predictive entity.

As an example, a predictive entity with a high-tenure high-reward hybrid temporal-utility classification may cause the predictive data analysis engine 110 to select the node 902 which corresponds to the high-tenure high-reward hybrid temporal-utility classification. Based at least in part on the predictive entity data object associated with the predictive entity, the predictive data analysis engine 110 may select one or more decision feature nodes associated with the high-tenure high-reward hybrid temporal-utility segment of the decision tree. The predictive data analysis engine 110 may continue to select decision feature nodes associated with the high-tenure high-reward hybrid temporal-utility segment of the decision tree until the leaf-level node 904 is reached.

In some embodiments, the one or more recommended engagement actions may include one or more recommend engagement programs to offer to the predictive entity, when to offer the one or more engagement programs to the predictive entity, the method of offering the one or more engagement programs, a priority ranking of the predictive entity relative to one or more other predictive entities for engagement programs, and/or the like.

Returning now to FIG. 4, at step/operation 405, the predictive data analysis engine 110 of the predictive data analysis computing entity 106 performs one or more prediction-based actions. In some embodiments, performing the one or more prediction-based actions may include automatically performing the one or more recommended engagement actions. For example, a recommended engagement action may recommend offering a program XYZ to the predictive entity via email. As such, the predictive data analysis engine 110 may automatically generate an email offering the program XYZ to the predictive entity and may provide the offer to an email associated with the predictive entity. In some embodiments, the email of the predictive entity may be described in the predictive entity data object. As another example, a recommended engagement action may recommend offering a program XYZ to the predictive entity via email on January 1^{st}, 2020. As such, the predictive data analysis engine 110 may automatically generate an email offering the program XYZ to the predictive entity and may provide the offer to an email associated with the predictive entity on January 1^{st}, 2020.

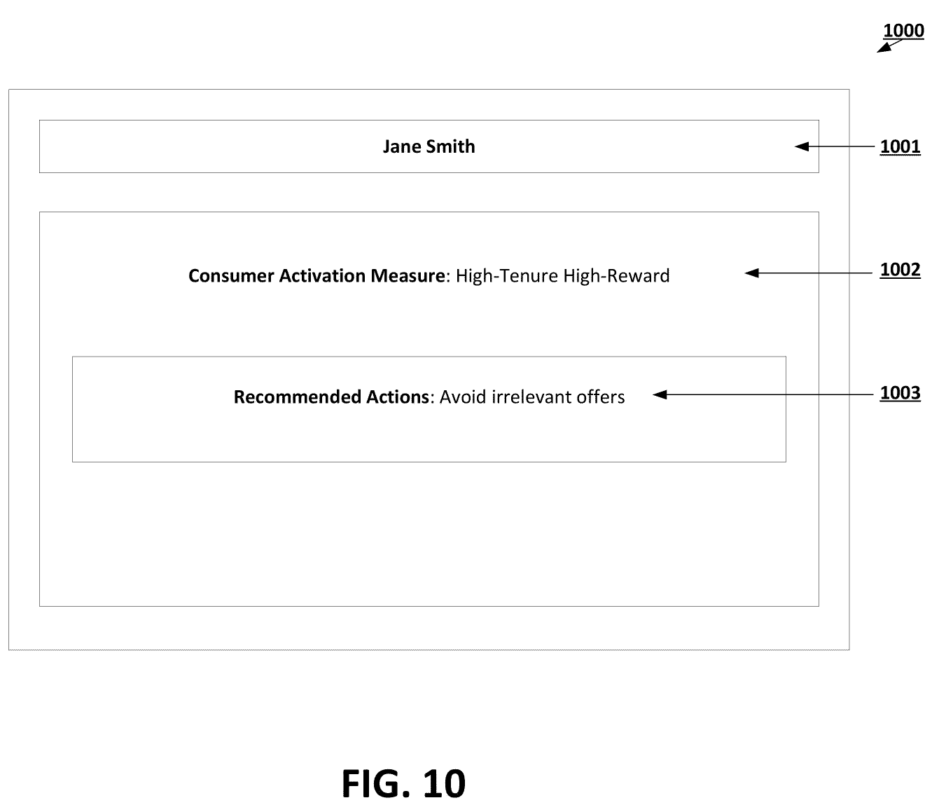

In some embodiments, the prediction-based actions comprises generating user interface data for a prediction output user interface that is configured to display the predictive output. For example, the prediction output user interface 1000 of FIG. 10 displays the recommended engagement action summary data object 1003 that is determined based at least in part on the one or more recommended engagement action for a particular predictive entity 1001. The prediction output user interface 1000 may also display the determined hybrid temporal-utility classification 1002 for the predictive entity.

Accordingly, various embodiments of the present invention introduce techniques for targeting engagement actions based at least in part on reliable hybrid temporal-utility classifications. The noted techniques are able to reduce operational load on user engagement systems by reducing the need for performing repeated/revised engagement actions, as reliable hybrid temporal-utility classifications enable selecting reliable and effective engagement actions and thus avoiding the need for repeated/revised engagement actions that would otherwise impose a substantial operational load on user engagement systems. In doing so, various embodiments of the present invention make important technical contributions to improving efficiency, effectiveness, and operational throughput of user engagement systems.

### VI. Conclusion

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. A computer-implemented method for dynamically determining a hybrid temporal-utility classification for a predictive entity, the computer-implemented method comprising:
determining, using one or more processors and a temporal classification score generation machine learning model, a temporal classification for the predictive entity, wherein: (i) the temporal classification score generation machine learning model is configured to determine a temporal classification score based at least in part on one or more temporal classification input features for the predictive entity, (ii) the temporal classification score describes a non-extremal periodicity likelihood measure for the predictive entity, (iii) the non-extremal periodicity likelihood measure is defined based at least in part on a non-extremal prospective period, (iv) the non-extremal prospective period is defined based at least in part on at least one of a lower extremal prospective period and an upper extremal prospective period, (v) the temporal classification is determined based at least in part on the temporal classification score and a temporal classification policy, and (vi) the one or more temporal classification input features include an entity cost density feature for the predictive entity;
determining, using the one or more processors and a utility classification score generation machine learning model, a utility classification for the predictive entity, wherein:
the utility score generation machine learning model is configured to: (i) for each timeseries processing machine learning model of a plurality of timeseries processing machine learning models, determine an error measure with respect to a historical utility timeseries data object associated with the predictive entity, (ii) generate a forecasted utility classification timeseries data object for the predictive entity based at least in part on an output of processing the historical utility timeseries data object using an error-minimizing timeseries processing machine learning model, and (iii) generate a utility classification score for the predictive entity based at least in part on the forecasted utility classification timeseries data object, and
the utility classification is determined based at least in part on the utility classification score and a utility classification policy;
determining, using the one or more processors and based at least in part on the temporal classification and the utility classification, the hybrid temporal-utility classification;
determining, using the one or more processors, one or more prediction-based actions based at least in part on the hybrid temporal-utility classification; and
performing the one or more prediction-based actions.

2. The computer-implemented method of claim 1, wherein determining the one or more prediction-based actions comprises:
identifying a decision tree data object, wherein: (i) a root-level node of the decision tree data object is associated with the hybrid temporal-utility classification, (ii) each decision tree segment of the decision tree data object is associated with a candidate hybrid temporal-utility classification of a plurality of hybrid temporal-utility classifications and comprises nodes corresponding to decision features associated with the candidate hybrid temporal-utility classification, and (iii) each leaf-level node of the decision tree data object is associated with a recommended engagement action of a plurality of candidate engagement actions; and
determining the one or more prediction-based actions based at least in part on the recommended engagement action of the leaf-level node of the decision tree data object that corresponds to the predictive entity.

3. The computer-implemented method of claim 1, wherein generating the utility classification score for the predictive entity based at least in part on the forecasted utility classification timeseries data object for the predictive entity comprises:
determining, based at least in part on the forecasted utility classification timeseries data object, a plurality of per-time-unit utility classification scores for the predictive entity, wherein each per-time-unit utility classification score is associated with a defined time unit of a plurality of defined time units of a prospective time period that is associated with the forecasted utility classification timeseries data object; and
determining the utility classification score based at least in part on each per-time-unit utility classification score.

4. The computer-implemented method of claim 1, wherein the plurality of timeseries processing machine learning models comprise an autoregressive forecasting machine learning model and an Unobserved Components Model (UCM).

5. The computer-implemented method of claim 1, wherein the autoregressive forecasting machine learning model comprises an Auto Regressive Integrated Moving Average (ARIMA) machine learning model.

6. The computer-implemented method of claim 1, wherein the temporal classification policy defines, for each distribution threshold of a plurality of distribution thresholds that are determined based at least in part on a cross-entity temporal classification score distribution for a plurality of historical predictive entities, a selected temporal classification of a plurality of defined temporal classifications.

7. The computer-implemented method of claim 1, wherein the utility classification policy defines, for each distribution threshold of a plurality of distribution thresholds that are determined based at least in part on a cross-entity utility classification score distribution for a plurality of historical predictive entities, a selected utility classification of a plurality of defined utility classifications.

8. The computer-implemented method of claim 1, wherein:
the temporal classification is selected from a plurality of defined temporal classifications,
the plurality of defined temporal classifications comprise an upper temporal classification, a lower temporal classification, and a medial temporal classification,
the utility classification is selected from a plurality of defined utility classifications, and
the plurality of defined utility classifications comprise an upper utility classification, a lower utility classification, and a medial utility classification.

9. The computer-implemented method of claim 8, wherein determining the hybrid temporal-utility classification comprises:
in response to determining that the temporal classification is the upper temporal classification and the utility classification is the lower utility classification, determining that the hybrid temporal-utility classification is a high-tenure low-reward hybrid temporal-utility classification.

10. The computer-implemented method of claim 8, wherein determining the hybrid temporal-utility classification comprises:
in response to determining that the temporal classification is the lower temporal classification and the utility classification is the lower utility classification, determining that the hybrid temporal-utility classification is a low-tenure low-reward hybrid temporal-utility classification.

11. The computer-implemented method of claim 8, wherein determining the hybrid temporal-utility classification comprises:
in response to determining that the temporal classification is the lower temporal classification and the utility classification is the upper utility classification, determining that the hybrid temporal-utility classification is a low-tenure high-reward hybrid temporal-utility classification.

12. The computer-implemented method of claim 8, wherein determining the hybrid temporal-utility classification comprises:
in response to determining that the temporal classification is the upper temporal classification and the utility classification is the upper utility classification, determining that the hybrid temporal-utility classification is a high-tenure high-reward hybrid temporal-utility classification.

13. The computer-implemented method of claim 8, wherein determining the hybrid temporal-utility classification comprises:
in response to determining that the temporal classification is the medial temporal classification, determining that the hybrid temporal-utility classification is a default hybrid temporal-utility classification.

14. The computer-implemented method of claim 8, wherein determining the hybrid temporal-utility classification comprises:
in response to determining that the utility classification is the medial utility classification, determining that the hybrid temporal-utility classification is a default hybrid temporal-utility classification.

15. An apparatus for dynamically determining a hybrid temporal-utility classification for a predictive entity, the apparatus comprising at least one processor and at least one memory including program code, the at least one memory and the program code configured to, with the processor, cause the apparatus to at least:
determine, using a temporal classification score generation machine learning model, a temporal classification for the predictive entity, wherein: (i) the temporal classification score generation machine learning model is configured to determine a temporal classification score based at least in part on one or more temporal classification input features for the predictive entity, (ii) the temporal classification score describes a non-extremal periodicity likelihood measure for the predictive entity, (iii) the non-extremal periodicity likelihood measure is defined based at least in part on a non-extremal prospective period, (iv) the non-extremal prospective period is defined based at least in part on at least one of a lower extremal prospective period and an upper extremal prospective period, (v) the temporal classification is determined based at least in part on the temporal classification score and a temporal classification policy, and (vi) the one or more temporal classification input features include an entity cost density feature for the predictive entity;
determine, using a utility classification score generation machine learning model, a utility classification for the predictive entity, wherein:
the utility score generation machine learning model is configured to: (i) for each timeseries processing machine learning model of a plurality of timeseries processing machine learning models, determine an error measure with respect to a historical utility timeseries data object associated with the predictive entity, (ii) generate a forecasted utility classification timeseries data object for the predictive entity based at least in part on an output of processing the historical utility timeseries data object using an error-minimizing timeseries processing machine learning model, and (iii) generate a utility classification score for the predictive entity based at least in part on the forecasted utility classification timeseries data object, and
the utility classification is determined based at least in part on the utility classification score and a utility classification policy;
determine, based at least in part on the temporal classification and the utility classification, the hybrid temporal-utility classification;
determine one or more prediction-based actions based at least in part on the hybrid temporal-utility classification; and
perform the one or more prediction-based actions.

16. The apparatus of claim 15, wherein performing the one or more prediction-based actions comprises further causing the apparatus to at least:
identify a decision tree data object, wherein: (i) a root-level node of the decision tree data object is associated with the hybrid temporal-utility classification, (ii) each decision tree segment of the decision tree data object is associated with a candidate hybrid temporal-utility classification of a plurality of hybrid temporal-utility classifications and comprises nodes corresponding to decision features associated with the candidate hybrid temporal-utility classification, and (iii) each leaf-level node of the decision tree data object is associated with a recommended engagement action of a plurality of candidate engagement actions; and
perform the one or more prediction-based actions based at least in part on the recommended engagement action of the leaf-level node of the decision tree data object that corresponds to the predictive entity.

17. The apparatus of claim 15, wherein generating the utility classification score for the predictive entity based at least in part on the forecasted utility classification timeseries data object for the predictive entity comprises further causing the apparatus to at least:
determine, based at least in part on the forecasted utility classification timeseries data object, a plurality of per-time-unit utility classification scores for the predictive entity, wherein each per-time-unit utility classification score is associated with a defined time unit of a plurality of defined time units of a prospective time period that is associated with the forecasted utility classification timeseries data object; and
determine the utility classification score based at least in part on each per-time-unit utility classification score.

18. The apparatus of claim 15, wherein the temporal classification policy defines, for each distribution threshold of a plurality of distribution thresholds that are determined based at least in part on a cross-entity temporal classification score distribution for a plurality of historical predictive entities, a selected temporal classification of a plurality of defined temporal classifications.

19. The apparatus of claim 15, wherein the utility classification policy defines, for each distribution threshold of a plurality of distribution thresholds that are determined based at least in part on a cross-entity utility classification score distribution for a plurality of historical predictive entities, a selected utility classification of a plurality of defined utility classifications.

20. A computer program product for dynamically determining a hybrid temporal-utility classification for a predictive entity, the computer program product comprising at least one non-transitory computer readable storage medium having computer-readable program code portions stored therein, the computer-readable program code portions configured to:
determine, using a temporal classification score generation machine learning model, a temporal classification for the predictive entity, wherein: (i) the temporal classification score generation machine learning model is configured to determine a temporal classification score based at least in part on one or more temporal classification input features for the predictive entity, (ii) the temporal classification score describes a non-extremal periodicity likelihood measure for the predictive entity, (iii) the non-extremal periodicity likelihood measure is defined based at least in part on a non-extremal prospective period, (iv) the non-extremal prospective period is defined based at least in part on at least one of a lower extremal prospective period and an upper extremal prospective period, (v) the temporal classification is determined based at least in part on the temporal classification score and a temporal classification policy, and (vi) the one or more temporal classification input features include an entity cost density feature for the predictive entity;
determine, using a utility classification score generation machine learning model, a utility classification for the predictive entity, wherein:
the utility score generation machine learning model is configured to: (i) for each timeseries processing machine learning model of a plurality of timeseries processing machine learning models, determine an error measure with respect to a historical utility timeseries data object associated with the predictive entity, (ii) generate a forecasted utility classification timeseries data object for the predictive entity based at least in part on an output of processing the historical utility timeseries data object using an error-minimizing timeseries processing machine learning model, and (iii) generate a utility classification score for the predictive entity based at least in part on the forecasted utility classification timeseries data object, and
the utility classification is determined based at least in part on the utility classification score and a utility classification policy;
determine, based at least in part on the temporal classification and the utility classification, the hybrid temporal-utility classification;
determine one or more prediction-based actions based at least in part on the hybrid temporal-utility classification; and
perform the one or more prediction-based actions.
